(19) United States
(12) Patent Application Publication
(10) Pub. No.: US 2002/0144441 A1
(43) Pub. Date: Oct. 10, 2002

(54) Light box with quickly changeable display panels

(76) Inventors: Randy L. Zentmire, Springfield, OR (US); Kimberly Zentmire, Springfield, OR (US)

Correspondence Address: Randy L. Zentmire, 970 South 55th Place, Springfield, OR, 97478, US

(21) Appl. No.: 09/829,119

(22) Filed: Apr. 9, 2001

(51) Int. Cl. G09F 13/04

(52) U.S. Cl. 40/575

(57) ABSTRACT

An illuminated box with a front loading display panel (18) having a rectangular retaining frame defining an enclosure and a front rectangular opening. The light box structure is comprised of a display housing (10), two side caps (14), a translucent panel (16), a changeable sign panel (18), and low voltage electrical lights (20). The light box uses low voltage lights (20) which are retained by openings (12) in rear side of the light box housing (10). The lights (20) project light beams through the front translucent panel (16) to illuminate the text, graphics, outlines, or photographs that are on the changeable display panel (18). The light box operates for the purpose of decorating and commemorating numerous holidays and special events by simply inserting and removing interchangeable display panels (18).

### CROSS-REFERENCE TO RELATED APPLICATIONS

Not applicable.

### BACKGROUND—FIELD OF INVENTION

This invention generally relates to illuminated display devices. More particularly, the invention relates to an improved illuminated sign box for text and graphics with quickly changeable display panels. The light boxes of this invention may be especially advantageously used to create quickly changeable lighted displays for special occasions such as Holidays.

### BACKGROUND—DESCRIPTION OF PRIOR ART

Numerous illuminated boxes have been provided in prior art. None of the prior art illuminated boxes provide a combination of low voltage illumination and quickly changeable display panels that can be changed without movement of any other part of the light box.

Prior art light boxes generally provide for the occasional, not frequent, changing of the display media, typically a transparent plastic sheet utilizing images formed thereon. U.S. Pat. No. 4,851,971 to MacLagan, Jul. 25, 1989 provides for front-loading of transparencies to allow more frequent changes of the displays but does not address low voltage lighting. Each side wall of the light box of U.S. Pat. No. 4,851,971 includes an L-shaped flange to provide a frame mounting flange wall. These flanges are not part of the light boxes of this invention.

The prior art light boxes also generally provide illumination from fluorescent lighting mounted on the rear side of the light box. The light boxes of U.S. Pat. No. 5,454,181 to Rothman, et al., Oct. 3, 1995 utilizes standard low voltage miniature lights for illumination and also includes display panels that are inserted in a track to hold them. The light box of this invention does not include tracks for the insertion of display panels.

U.S. Pat. No. 6,098,326 to Campbell, Aug. 8, 2000 includes low voltage miniature lights mounted on an assembly panel located inside the light box. The light box of this invention does not include an assembly panel for the lights.

Several prior art light boxes require the movement of some part of the light box other than the display panel in order to change the display panel. Light boxes of this type include U.S. Pat. No. 4.254.457 to Lordier, Mar. 3, 1981; U.S. Pat. No. 1,857,882 to Shipman, May 10, 1932; U.S. Pat. No. 4,380,880 to Gandy, Apr. 26, 1983: U.S. Pat. No. 4,766,685 to Kramer, Aug. 33, 1988; and U.S. Pat. No. 4,387,522 to Sommers-Szoszky, Jun. 14, 1983.

### SUMMARY

This invention is an illuminated light box with display panels that can be quickly changed for special occasions such as Holidays. The light box can be used outdoors or indoors and utilizes standard low voltage lights for backlighting. A transparent or translucent display panel bearing one or more decorative or informational images is mounted within the rectangular opening defined by the frame.

### OBJECTS AND ADVANTAGES

Accordingly, several objects and advantages of this light box are:

(a) To provide a light box where the display panels can be changed in seconds without any movement of the other parts of the light box;

(b) To provide a display that can easily be used year round for numerous occasions such as Christmas, New Years, birthdays, Holidays, etc;

(c) To provide a display that would use standard low voltage Christmas lights;

(d) To provide a display that can be used indoors or outdoors;

Other objects and advantages are;

(a) To provide a display that can display text, graphics, outlines, or photographs;

(e) To provide a light-weight display that can be easily installed and easily removed;

(f) To provide a display that can be made from inexpensive materials;

(b) To provide a display that can be used alone, in multiples, side by side, or stacked;

(c) To provide a display that can be easily stored;

(d) To provide a durable display;

(e) To provide a light box that can display a variety of display materials such as transparencies, decals, cut outs, and stickers.

Further objects and advantages of my invention will become apparent from a of the drawings and ensuing description.

### BRIEF DESCRIPTION OF THE DRAWING

FIG 1. is a perspective view of the assembled light box.

FIG 2. is an exploded perspective view of the light box.

FIG. 3. is a cross sectional perspective view along lines 3-3 of FIG. 1.

### REFERENCE NUMERALS IN DRAWINGS

10 Housing

11 Lip of Housing 10

12 Opening in housing 10 for low voltage lights 20

14 Side cap for housing 10

15 Channel in side cap 14

16 Translucent panel

18 Display panel

20 Low voltage lights

### DETAILED DESCRIPTION OF THE INVENTION

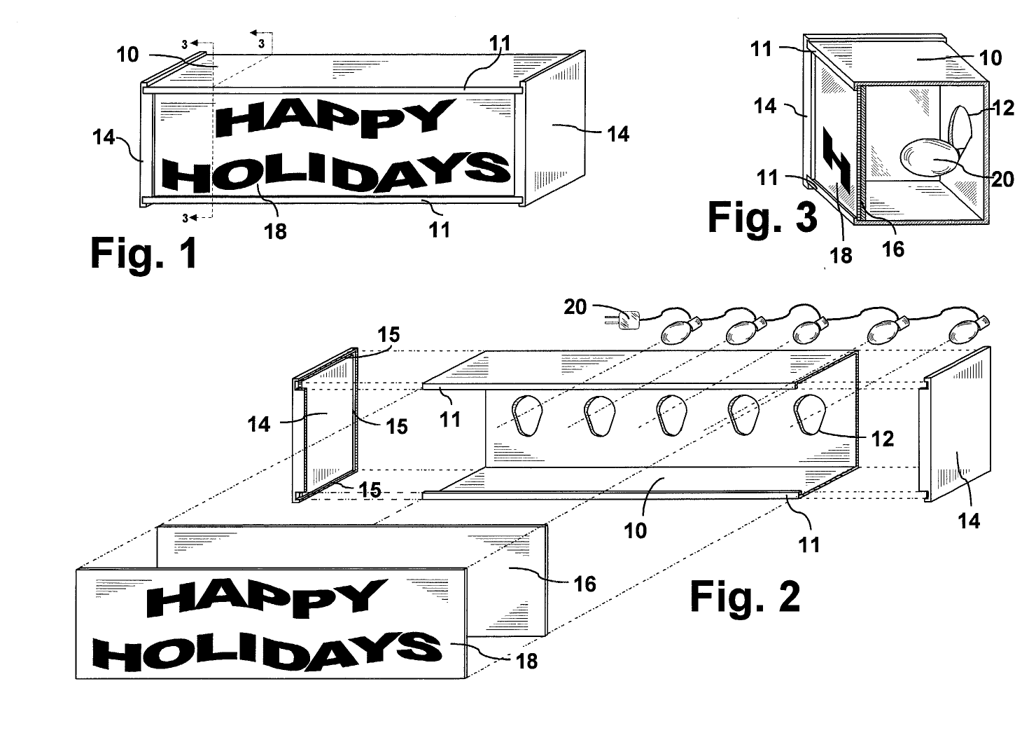

FIG. 1 is a perspective view of the assembled light box and FIG. 2 is an exploded perspective view of the light box. The main support structure of the light box is a housing 10. While a number of materials such as plastic, wood, or metal, could be used for construction of housing 10, the preferred construction is a vinyl or PVC rain gutter cut to the desired length. The vinyl or PVC rain gutter material is an excellent material to use outdoors. The interior of the vinyl or PVC rain gutter is light enough to provide reflective properties for lights 20. Housing 10 provides three complete sides of the rectangular shaped light box—top, back, and bottom. Housing 10 also provides a Lip 11 on the front side of the light box—a portion at the top and at the bottom of the front side forming a frame to hold a translucent panel 16 and a display panel 18 in the front of the light box. Housing 10 can be various lengths as desired, but typically between 60 centimeters to 200 centimeters long.

Housing 10 contains a plurality of openings 12 for low voltage lights 20 as shown in FIG. 2. Openings 12 are shaped to allow for insertion of lights 20 and to adequately hold them in place. The shape of openings 12 will vary depending on the shape of lights 20. The preferred shape of openings 12 is a large circular opening at top to allow for the insertion of light 20 then tapering down to a smaller circular opening at the bottom to restrain lights 20 from falling out of housing 10. The preferred material for lights 20 are standard low voltage Christmas lights. Other forms of lights such as fluorescent lights, battery powered lights, or incandescent lighting can be used for lights 20. Openings 12 allow for easy removal of lights 20 for replacement of burned out bulbs. FIG. 3 shows how lights 20 are positioned into housing 10. The number of openings 12 can be varied to provide more or less light intensity. Typically there will be about two openings 12 per every 30 centimeters of length of housing 10.

As shown in FIG. 1 and FIG. 3, a translucent panel 16 is inserted in housing 10 to form the front of the light box. Lip 11 is at the front of housing 10 and is “L” shaped to provide a frame at the top and bottom for translucent panel 16 and display panel 18. FIG. 3 shows the positioning of translucent panel 16 within housing 10. This prevents translucent panel 16 from falling out of housing 10. Any translucent material can be used for translucent panel 16 such as plastic or glass. The preferred material for translucent panel 16 is styrene plastic similar to that used in drop ceiling panels for fluorescent lights. Translucent panel 16 is rectangular shaped and should be sized to provide a snug fitting within housing 10. The translucent quality of translucent panel 16 allows for proper illumination of display panel 18 by lights 20.

Two side caps 14 are attached to housing 10, one at each side as shown in FIG. 1 and FIG. 2. As shown in FIG. 2, side cap 14 is rectangular shaped and has a rectangular shaped channel 15 that housing 10 is inserted into. The side of translucent panel 16 is inserted into the front part of channel 15 of side cap 14. Channel 15 serves to hold housing 10, translucent panel 16, and side cap 14 together. The dimensions of channel 15 are such as to provide a snug fit for housing 10 and translucent panel 16. As shown in FIG. 2, side cap 14 protrudes slightly in front to provide a frame for retaining the sides of translucent panel 16. The side of channel 15 that will be towards the front of the assembled light box is slightly wider than the width of translucent panel 16 and display panel 18 combined. This allows for the easy insertion and retention of display panel 18 into housing 10 and serves to hold translucent panel 16 and display panel 18 in place. When the preferred material of a vinyl or PVC rain gutter is used for housing 10, the preferred material for side cap 14 is a standard vinyl or PVC rain gutter end cap as this can be utilized without any modification. Side cap 14 can be made from many other materials such as plastic, wood, or metal.

Display panel 18, as shown in FIG. 1 and FIG. 2, is attached to the assembled light box by slightly bending display panel 18 and inserting it behind the frame formed by lip 11 and side caps 14 and in front of translucent panel 16. Display panel 18 is generally rectangular shaped with dimensions that allow for the easy insertion and retention into housing 10. The thickness of display panel 18 should be thin enough to allow for bending for insertion into housing 10 but not so thin as to be flimsy and thus fall out of housing 10. Display panel 18 can be made from a variety of materials that would work well with backlighting displays. These materials could include clear plastic sheets, transparency material, decals, stickers, and cut-out materials. The preferred material is transparency material like that used for overhead transparency projectors. Display panel 18 can be removed in seconds allowing for frequent changes of the display. Display panel 18 could be used to display text, graphics, outlines, silhouettes, or photographs. Display panel 18, as shown in FIG. 1 and FIG. 2, is an example of a display of the text “Happy Holidays.”

FIG. 3 shows a cross sectional perspective view along lines 3-3 of the assembled light box in FIG. 1. The view in FIG. 3 shows how the display panel 18 and translucent panel 16 are positioned inside housing 10. FIG. 3 also shows how lip 11 forms a frame at the top and bottom of the front opening of the light box and provides retention of display panel 18 and translucent panel 16.

Conclusion, Ramifications, and Scope.

The light box of this invention provides a lightweight, easy to use, inexpensive illuminated light box with display panels that can be changed in seconds. The display panels can be quickly changed for numerous special occasions such as Holidays. The light box can be used outdoors or indoors and utilizes standard low voltage lights for backlighting.

When the light box is made with the preferred materials of PVC rain gutter, PVC rain gutter end caps, styrene plastic translucent panel, low voltage Christmas lights, and a transparency display panel—the light box becomes very light-weight, durable, and inexpensive. Other materials can be used for the various parts and still result in the same benefits.

The light box provides an extremely versatile display that can easily provide displays to celebrate numerous holidays and special events. The displays can be text, graphics, or photographs. The displays can also be made from a variety of display materials such as transparencies, decals, cut outs, and stickers.

The light box can be easily mounted and easily removed, can be used alone or in multiples, can be displayed side-by-side or stacked, and can be easily stored. Numerous light boxes can be hung from the eves of a house similar to where outdoor Christmas lights are hung. The light boxes can be left up all year long. The light boxes can also be used to display a house addresses or a resident's name.

Accordingly, the scope of the invention should be determined not by the embodiment(s) illustrated, but by the appended claims and their legal equivalents.

1. An illuminated box comprising:
(a) a housing that forms:
(1) the top, back, and bottom sides of the box, and
(2) a frame at the upper and lower portion of the front side of said box, and
(b) a source of illumination, and
(c) a plurality of openings in the back side of said housing that provides a means for allowing inserting and securing said source of illumination, and
(d) a translucent panel that forms the front side of said box and is positioned behind said frame of said housing, and
(e) a removable display panel positioned in front of said translucent panel and behind said frame of said housing, and
(f) two side panels that provide:
(1) the sides of said box, and
(2) a means for securing said housing, said translucent panel, and said display panel together,
whereby said display panel can be quickly and easily inserted and removed without the movement of any other part of said box.

2. The illuminated box as defined in claim 1 wherein said source of illumination further include low voltage lights.

3. The illuminated box as defined in claim 1 wherein said side panel means for securing further include a plurality of internal channels in each said side panel parallel to and near all the edges of said side panels as a means for connecting said side panels, said housing, said translucent panel, and said display panel together.

4. The illuminated box as defined in claim 1 wherein said housing is further composed of rain gutter material and said side panels are composed of rain gutter end caps.

5. The illuminated box as defined in claim 1 wherein said display panel is further composed of overhead transparency material.
